(19) United States
(12) Patent Application Publication
(10) Pub. No.: US 2024/0394516 A1
(43) Pub. Date: Nov. 28, 2024

(54) GENERATING PREDICTIONS FOR NON-STATIONARY DATA USING DISTRIBUTIONS OVER OUTPUT HEAD WEIGHTS

(71) Applicant: DeepMind Technologies Limited, London (GB)

(72) Inventors: Michail Titsias, London (GB); Alexandre Galashov, London (GB)

(21) Appl. No.: 18/666,682

(22) Filed: May 16, 2024

(30) Foreign Application Priority Data
May 17, 2023 (GR) 20230100402

(51) Int. Cl. G06N 3/047; G06N 3/098

(52) U.S. Cl. CPC G06N 3/047; G06N 3/098

(57) ABSTRACT

Methods, systems, and apparatus, including computer programs encoded on a computer storage medium, for implementing online inference and learning using a neural network and Bayesian filtering. In one aspect, a method includes: receiving a data stream including a respective input at each of multiple time steps; and processing the data stream to generate a respective predicted output at each time step, including, at each time step: receiving the input at the time step; obtaining a set of distribution parameters for the time step that parametrizes a transition distribution for the time step; generating a set of weights for the time step using the set of distribution parameters for the time step; parametrizing an output network head of the neural network with the set of weights for the time step; and processing the input at the time step using the neural network to generate the predicted output at the time step.

### CROSS-REFERENCE TO RELATED APPLICATION

This application claims the benefit under 35 U.S.C. § 119 (a) of the filing date of Greek patent application Ser. No. 20/230,100402, filed in the Greek Patent Office on May 17, 2023. The disclosure of the foregoing application is herein incorporated by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes an online inference and learning system implemented as computer programs on one or more computers in one or more locations that can process a data stream, e.g., a non-stationary data stream, to perform online inference on the data stream, online learn one or more machine learning tasks from the data stream, and adapt to statistical fluctuations in the data stream.

A data stream can include: (i) a respective input, and (ii) a corresponding ground truth output, at each of multiple time steps. In general, the system is configured to process the data stream, using a neural network and probabilistic Bayesian filtering, to generate a respective predicted output at each time step that estimates the corresponding ground truth output for the time step.

These and other features of the online inference and learning system described herein are summarized below.

According to a first aspect, a method performed by one or more computers for online inference is described. The method involves a neural network including a base neural network and an output network head.

The method includes: receiving a data stream including a respective input at each of multiple time steps; and processing the data stream to generate a respective predicted output at each time step that estimates a corresponding ground truth output for the time step.

Processing the data stream includes, at each time step: receiving the input at the time step; obtaining a set of distribution parameters for the time step that parametrizes a transition distribution for the time step, where the transition distribution for the time step defines a conditional probability distribution over possible sets of weights for the time step, given a set of weights for a previous time step; generating a set of weights for the time step using the set of distribution parameters for the time step; parametrizing the output network head with the set of weights for the time step; and processing the input at the time step using the neural network to generate the predicted output at the time step, including: processing the input at the time step using the base neural network to generate an embedding of the input at the time step; and processing the embedding of the input at the time step using the output network head, in accordance with the set of weights for the time step, to generate the predicted output at the time step.

In some implementations of the method, at each time step: the transition distribution for the time step is a linear Gaussian transition distribution, and the set of distribution parameters for the time step includes a forgetting coefficient for the time step.

In some implementations of the method, at each time step: the linear Gaussian transition distribution for the time step is variance-preserving, and the set of distribution parameters for the time step consists of: (i) the forgetting coefficient for the time step, and (ii) a fixed variance.

In some implementations of the method, at each time step, generating the set of weights for the time step using the set of distribution parameters for the time step includes: generating the transition distribution for the time step in accordance with the set of distribution parameters for the time step; and sampling the set of weights for the time step from the transition distribution for the time step.

In some implementations of the method, the data stream further includes the respective ground truth output at each time step, and processing the data stream further includes, at each time step: receiving the ground truth output at the time step; and generating a set of distribution parameters for a next time step using: (i) the set of distribution parameters for the time step, (ii) the embedding of the input at the time step, and (iii) the ground truth output at the time step.

In some implementations of the method, at each time step, generating the set of distribution parameters for the next time step includes: generating a predictive posterior distribution for the time step that depends on: (i) the set of distribution parameters for the time step, and (ii) the embedding of the input at the time step, where the predictive posterior distribution for the time step defines a conditional probability distribution over possible ground truth outputs for the time step, given the ground truth output at each previous time step; determining, from the predictive posterior distribution for the time step, a conditional probability of the ground truth output at the time step, given the ground truth output at each previous time step; generating an objective function for the time step that depends on the conditional probability of the ground truth output at the time step; and generating the set of distribution parameters for the next time step by optimizing the objective function for the time step with respect to the set of distribution parameters for the time step.

In some implementations of the method, at each time step, the base neural network is configured to process the input at the time step, in accordance with a set of network parameters for the time step, to generate the embedding of the input at the time step, and processing the data stream further includes, at each time step: obtaining the set of network parameters for the time step; parametrizing the base neural network with the set of network parameters for the time step; and generating a set of network parameters for the next time step by optimizing the objective function for the time step with respect to the set of network parameters for the time step.

In some implementations of the method, the method further includes, before processing the data stream: initializing the set of network parameters for a first of the time steps.

In some implementations of the method, the set of network parameters for the first time step are initialized as a pre-trained set of network parameters.

In some implementations of the method, the set of network parameters for the first time step are initialized as a random set of network parameters.

In some implementations of the method, at each time step, the objective function for the time step includes a logarithm of the conditional probability of the ground truth output at the time step.

In some implementations of the method, at each time step, generating the predictive posterior distribution for the time step includes: generating a marginal predictive posterior distribution for the time step that depends on the set of distribution parameters for the time step, where the marginal predictive posterior distribution for the time step defines a conditional probability distribution over possible sets of weights for the time step, given the ground truth output at each previous time step; generating a likelihood distribution for the time step that depends on the embedding of the input at the time step, where the likelihood distribution for the time step defines a conditional probability distribution over possible ground truth outputs for the time step, given the set of weights for the time step; and marginalizing, with respect to the possible sets of weights for the time step, the likelihood distribution for the time step over the marginal predictive posterior distribution for the time step.

In some implementations of the method, at each time step, marginalizing, with respect to the possible sets of weights for the time step, the likelihood distribution for the time step over the marginal predictive posterior distribution for the time step includes: performing a Monte Carlo estimation over the possible sets of weights for the time step.

In some implementations of the method, at each time step, the likelihood distribution for the time step is a Gaussian likelihood distribution or a softmax likelihood distribution.

In some implementations of the method, at each time step, generating the marginal predictive posterior distribution for the time step includes: obtaining a marginal posterior distribution for the previous time step, where the marginal posterior distribution for the previous time step defines a conditional probability distribution over possible sets of weights for the previous time step, given the ground truth output at each previous time step; generating the transition distribution for the time step in accordance with the set of distribution parameters for the time step; and marginalizing, with respect to the possible sets of weights for the previous time step, the transition distribution for the time step over the marginal posterior distribution for the previous time step.

In some implementations of the method, processing the data stream further includes, at each time step: determining, from the likelihood distribution for the time step, a conditional likelihood of the ground truth output at the time step, given the set of weights for the time step; and generating, via Bayes' rule, a marginal posterior distribution for the time step in accordance with the conditional likelihood of the ground truth output at the time step and the marginal predictive posterior distribution for the time step, where the marginal posterior distribution for the time step defines a conditional probability distribution over possible sets of weights for the time step, given the ground truth output at the time step and each previous time step.

In some implementations of the method, the method further includes, before processing the data stream: initializing an initial set of distribution parameters that parametrizes a prior distribution, where the prior distribution defines a probability distribution over possible sets of weights prior the first time step; and generating an initial set of weights using the initial set of distribution parameters.

In some implementations of the method, generating the initial set of weights using the initial set of distribution parameters includes: generating the prior distribution in accordance with the initial set of distribution parameters; and sampling the initial set of weights from the prior distribution.

In some implementations of the method, the method further includes, before processing the data stream: initializing the set of distribution parameters for the first time step that parametrizes the transition distribution for the first time step, where the transition distribution for the first time step defines a conditional probability distribution over possible sets of weights for the first time step, given the initial set of weights prior the first time step.

In some implementations of the method, the set of distribution parameters for the first time step parametrizes the transition distribution for the first time step as a delta function.

In some implementations of the method, the prior distribution is a Gaussian prior distribution.

In some implementations of the method, the base neural network is a pre-trained neural network.

In some implementations of the method, the output network head comprises one or more linear neural network layers.

In some implementations of the method, the data stream is non-stationary.

According to a second aspect, a system including one or more computers and one or more storage devices communicatively coupled to the one or more computers is described. The one or more storage devices store instructions that, when executed by the one or more computers, cause the one or more computers to perform operations of any of the abovementioned methods.

According to a third aspect, a system including one or more non-transitory computer storage media is described. The one or more non-transitory computer storage media store instructions that, when executed by one or more computers, cause the one or more computers to perform operations of any of the abovementioned methods.

Throughout this specification, an “embedding” of an entity can refer to a representation of the entity as an ordered collection of numerical values, e.g., a vector or matrix of numerical values, in a latent space (e.g., a lower-dimensional space than the input space in which the entity is represented). An embedding of an entity can be generated, e.g., as the output of a neural network that processes data characterizing the entity.

As used herein, “stationary data” refers to data that has constant statistical properties throughout time, while “non-stationary data” refers to data that is not stationary, i.e., to data that does not have constant statistical properties throughout time. Examples of statistical properties and/or statistical parameters include means, variances, and covariances which, for non-stationary data, generally change with time unpredictably. Examples of non-stationary behavior can include, but are not limited to, trends, cycles, random walks, changes in machine learning tasks, or combinations thereof.

The online inference and learning system described herein can be configured to perform any of a variety of machine learning tasks on a data stream, as well as simultaneously learn any of a variety of new machine learning tasks from observations included in the data stream. For example, the system can learn and perform many machine learning tasks sequentially on the data stream without forgetting knowledge obtained from the preceding tasks.

For example, the system can be configured to perform any of a variety of classification tasks. That is, the predicted output for each input is a classification output for the input and the ground truth output is a ground truth classification for the input. As used in this specification, a classification task is any task that that requires the system to generate an output that includes a respective score for each of a set of multiple categories and, optionally, to then select one or more of the categories as a “classification” for the input using the respective scores.

One example of a classification task is image classification, where the input is an image, i.e., the intensity values of the pixels of the image, the categories are object categories, and the task is to classify the image as depicting an object from one or more of the object categories. That is, the classification output for a given input image is a prediction of one or more object categories that are depicted in the input image.

Another example of a classification task is text classification, where the input is text and the task is to classify the text as belonging to one of multiple categories. One example of such a task is sentiment analysis task, where the categories each correspond to different possible sentiments of the task. Another example of such a task is a reading comprehension task, where the input text includes a context passage and a question and the categories each correspond to different segments from the context passage that might be an answer to the question. Other examples of text processing tasks that can be framed as classification tasks include an entailment task, a paraphrase task, a textual similarity task, a sentiment task, a sentence completion task, a grammaticality task, and so on.

Other examples of classification tasks include speech processing tasks, where the input to the neural network is audio data representing speech. Examples of speech processing tasks include language identification (where the categories are different possible languages for the speech), hotword identification (where the categories indicate whether one or more specific “hotwords” are spoken in the audio data), and so on.

As another example, the task can be a health prediction task, where each input is medical data, e.g., health record data, medical imaging data, diagnostic test results, and so on for a patient and the categories are respective predictions that are relevant to the future health of the patient, e.g., a predicted treatment that should be prescribed to the patient, the likelihood that an adverse health event will occur to the patient, or a predicted diagnosis for the patient.

Alternatively, the system can be configured to perform any of a variety of regression tasks. That is, the predicted output for each input is a predicted regression output for the input and the ground truth output is a ground truth regression output for the input. As used in this specification, a regression task is any task that that requires the system to output one or more regressed values.

For example, the task can be an agent or machine control task, each input can characterize the state of the agent or machine, e.g., as measured by one or more sensors that sense a real-world environment, and the output can define a control input for the agent or the machine. Examples of agents include robots or autonomous vehicles. Examples of machines include items of equipment in a manufacturing plant, or a service facility such as a data center, server farm, or grid mains power or water distribution system, or an electrical power generation facility such as a solar or wind farm. That is, the system may control or impose operating conditions on the items of equipment, e.g., adjust a setting of an item of equipment, or turn the item of equipment on or off, or adjust a wind turbine or solar collector alignment.

The subject matter described in this specification can be implemented in particular embodiments so as to realize one or more of the following advantages.

In Online Continual Learning (OCL), an agent (or generic system) receives a stream of data and sequentially performs prediction and training steps. Prominent challenges in OCL are concerned with automatic adaptation to the particular non-stationary structure of the data steam, as well as quantification of predictive uncertainty.

Considering these challenges, this specification introduces an online inference and learning system implementing a neural network and probabilistic Bayesian filtering for computationally fast and efficient OCL. In the described examples of the system, the neural network includes: (i) a base neural network for representation learning, and (ii) an output network head for classifying readout. The system implements a prior model over the weights of the output network head while performing prediction and update steps via Bayesian filtering to track the marginal posterior distribution online over the output weights. Particularly, the system performs online updates, e.g., stochastic gradient descent (SGD) updates, on a set of distribution parameters that parameterize the transition (or “dynamical”) distribution of the prior model. This allows the system to automatically adjust to non-stationarity observed in the data stream. Moreover, the Bayesian OCL implemented by the system allows simultaneous and stable online training (or fine-tuning) of the neural network.

In some implementations, the system uses a state space model (e.g., a linear Gaussian or diffusion model) for the transition distribution, parametrized by a forgetting coefficient that quantifies the degree of “memory” the system has of past observations in the data stream. In these cases, the system can perform predictions by implementing computationally efficient and low latency Kalman filter recursions, while flexibly adapting to non-stationarity in the data via online updates of the forgetting coefficient. For example, the Kalman filter recursions generally involve a fixed number of computations at each time step which, in many implementations, is on the order of ˜O(d²), where d is the size of the base neural network's embedding space. Moreover, in general, the Kalman filter model does not need to store additional data in memory beyond the Kalman statistics and the parameters of the neural network at the time step. Hence, the system can be computationally fast and memory cheap, and implementable in situations where computational resources such as processing power and memory are scarce, e.g., mobile devices, tablets, laptops, edge computing devices, etc. The predictive ability of the Kalman filter model, and its flexibility to capture non-stationarity, was demonstrated in a set of experiments involving regression on an artificial, non-stationary data stream and multi-class classification on data sets such as CIFAR-100and CLOC. The results of which are provided herein.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1C are block diagrams of an example online inference and learning system implementing a neural network and probabilistic Bayesian filtering.

FIGS. 2A-2D are flow diagrams of an example process for performing online inference and learning on a data stream using a neural network and probabilistic Bayesian filtering.

FIGS. 3A-3C are experimental plots showing results of an experiment that was performed by example configurations of the online inference and learning system for tracking an artificial, non-stationary data stream.

FIGS. 4A-4B are experimental plots showing results of an experiment that was performed by example configurations of the online inference and learning system for online classification on CIFAR-100.

FIGS. 5A-5B are experimental plots showing results of an experiment that was performed by example configurations of the online inference and learning system for online classification on CLOC.

Like reference numbers and designations in the various drawings indicate like elements.

### DETAILED DESCRIPTION

Continual Learning (CL) is an open machine learning problem that has received increasing attention in recent years. In general, CL involves training and using machine learning models in non-stationary scenarios, e.g., training a machine learning model on many, disparate machine learning tasks sequentially while not forgetting knowledge obtained from the preceding tasks. Different, and sometimes conflicting, specifications have been considered for CL, including forward transfer, backward transfer, avoiding catastrophic forgetting, and maintaining plasticity. Moreover, CL is typically subject to several constraints, such as limited memory to store training data, limited model sizes to allow faster processing of data, and computational constraints.

To overcome some, or all, of these abovementioned challenges, this specification introduces an online inference and learning system for highly accurate, computationally fast, and memory cheap online inference and learning. At a high-level, the system receives a data stream including a respective input xₙ at each of multiple time steps. At each time step n, the system first observes the input xₙ, and generates a predicted output ŷₙ that estimates a corresponding ground truth output yₙ for the time step. In some implementations, the data stream also includes the respective ground truth output yₙ at each time step. Here, the system can receive the associated loss and ground truth output for learning.

More particularly, the system utilizes a neural network and probabilistic Bayesian filtering which explicitly takes into account non-stationaries in the data stream. The system implements a prior model over the output weights of the neural network using a “parameter drift” transition distribution. The parameters of the transition distribution can include a forgetting coefficient that quantifies the forgetting of information over the data stream. The system combines the prior model with observations of the data stream using online Bayesian updates, e.g., implemented as computationally fast Kalman filter recursions, that track the posterior distribution over the output weights as the data distribution changes over time. The system also combines these Bayesian updates with online stochastic gradient descent (SGD) updates on the parameters of the transition distribution, e.g., the forgetting coefficient, allowing for flexible adaptation to non-stationarity.

In the described examples of the system, the neural network is separated into: (i) a base neural network for generating representations, and (ii) an output network head for classifying readout. This modularity can provide generic, stable representations across a multitude of machine learning tasks, allowing non-stationarity to be handled entirely (or almost entirely) by the output network head. For example, the base neural network can be a frozen, pre-trained neural network where only the output network head is updated online while processing the data stream. In other cases, the base neural network can be a pre-trained neural network that is fine-tuned online while processing the data stream. In these and other applications, simultaneously online learning the representation and performing Bayesian filter updates can lead to stable learning. Experimental results of the system on Online Continual Learning (OCL) benchmarks are also provided herein.

These features and other features relating to the online inference and learning system are described in more detail below.

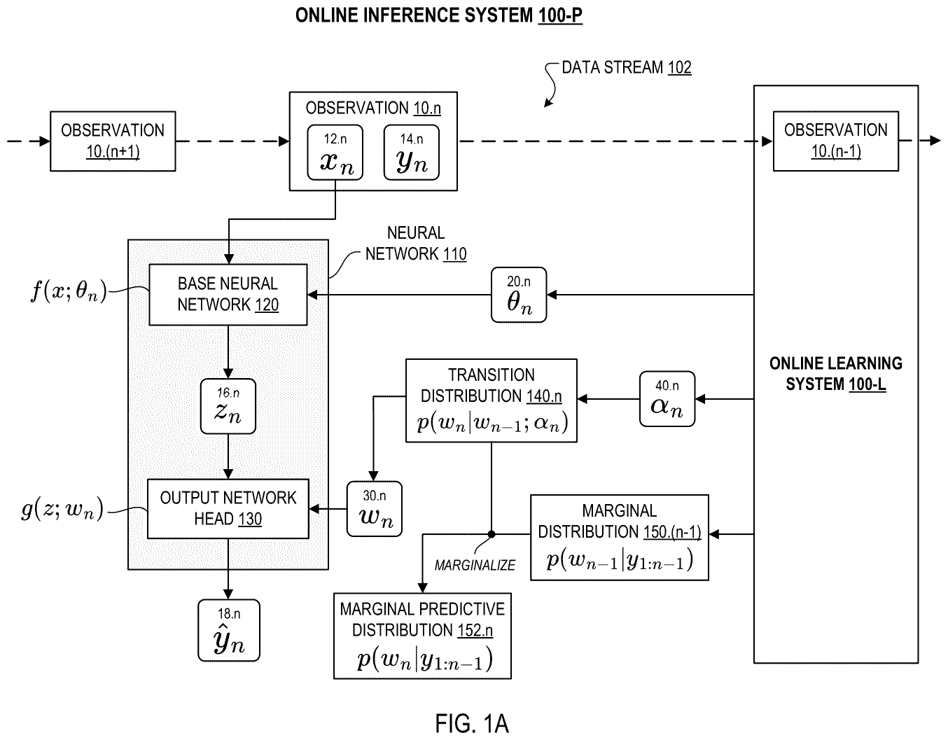

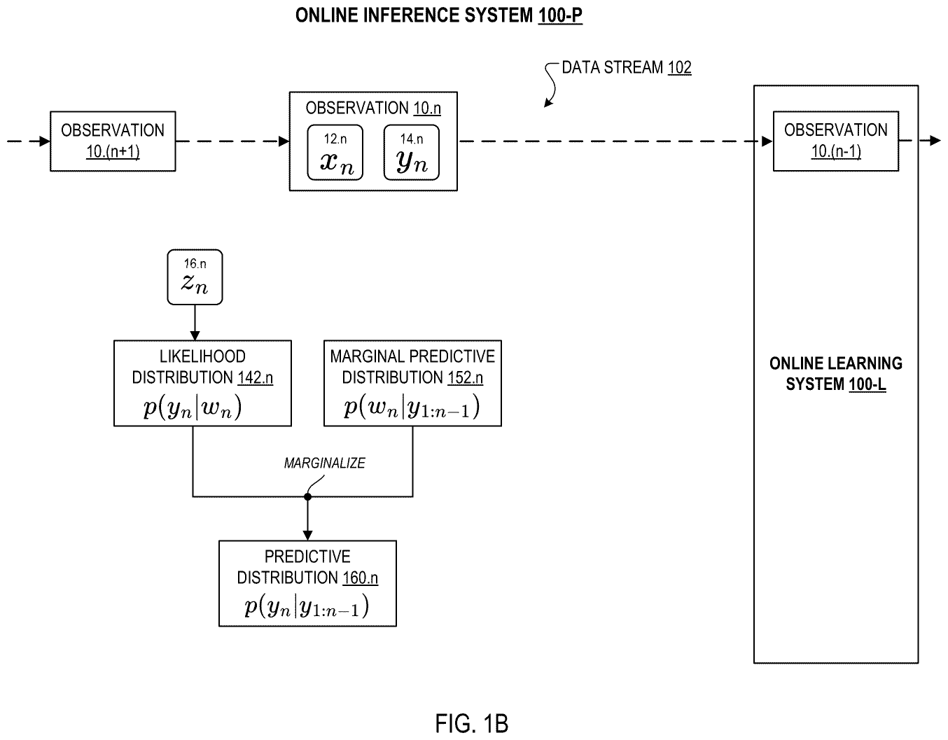

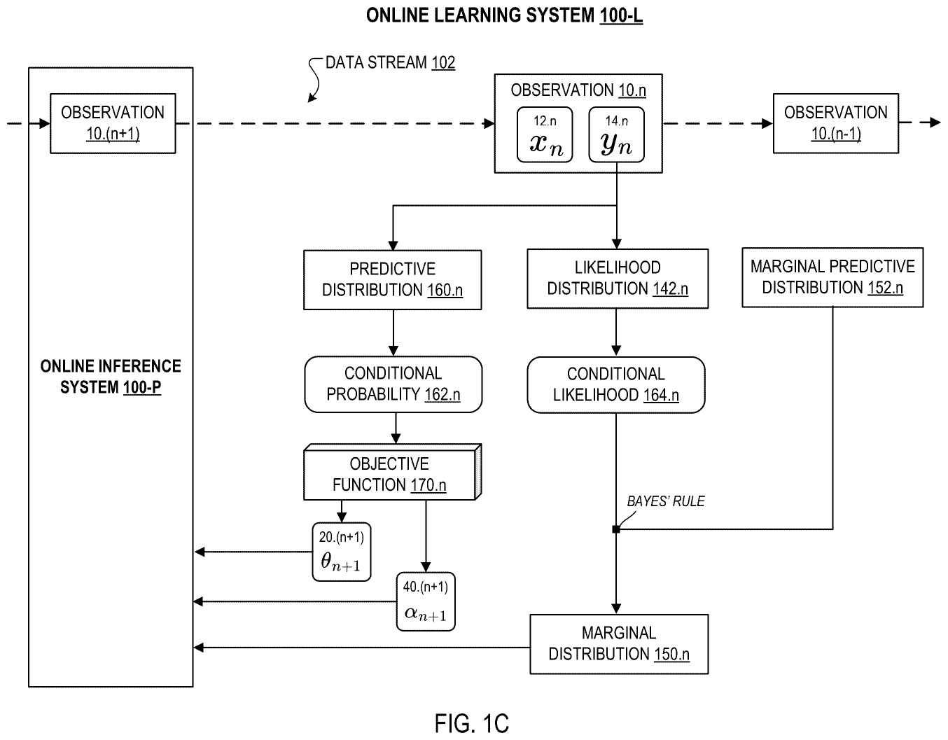

FIGS. 1A-1C are block diagrams of an example online inference and learning system 100. The system 100 is an example of a system implemented as computer programs on one or more computers in one or more locations in which the systems, components, and techniques described below are implemented.

For case of description, the system 100 is depicted in FIGS. 1A-1C as including: (i) an online inference (or prediction) system 100-P, and (ii) an online learning (or updating) system 100-L. In general, the inference system 100-P, as depicted in FIGS. 1A-1B, is configured to generate predictions 18 in response to inputs 12 from an incoming stream of data 102. On the other hand, the learning system 100-L, as depicted in FIG. 1C, is configured to update the parameters of the inference system 100-P via probabilistic Bayesian filtering and stochastic gradient descent (SGD) after receiving the ground truth outputs 14 from the data stream 102 and computing the associated losses for optimization.

In more detail, the system 100 is configured to receive the data stream 102 that includes a respective observation 10.n at each of multiple time steps t=1, 2 . . . , n−1, n, n+1, . . . . N, where t=1 is the first time step and N is the total number of time steps in the data stream 102. For case of description, an initialization time step t=0 is referred to herein and denotes any time before the system 100 begins processing the data stream 102. Note, for continual online inference and learning, the total number of time steps in the data stream 102 may approach N>∞, or some very large number of time steps, before the data stream 102 is terminated by the system 100, or interrupted by some other means, e.g., a client terminating a communication channel with the system 100 or a loss of connectivity with the communication channel. For example, the data stream 102 may include 10³ or more time steps, 10⁴ or more time steps, 10⁵ or more time steps, 10⁶ or more time steps, 10⁷ or more time steps, 10⁸ or more time steps, 10⁹ or more time steps, and so on.

Each observation 10.n of the data stream 102 is a respective tuple that includes: (i) a respective input (xₙ) 12.n, and (ii) a corresponding ground truth output (yₙ) 14.n for the respective input 12.n. The system 100 is configured to process the data stream 102, using a neural network 110 and probabilistic Bayesian filtering, to generate a respective predicted output (ŷₙ) 18.n at each time step that estimates the corresponding ground truth output 14.n for the time step (ŷₙ˜yₙ).

Note, however, the system 100 generally does not need to generate a predicted output 18.n for each individual input 12.n, although the system 100 can. For example, the system 100 can observe a batch of observations 10 and generate a predicted output 18 for the batch after observing the last input 12 in the batch. Moreover, when generating a predicted output 18.n for an input 12.n, the system 100 generally observes the corresponding ground truth output 18.n after making the prediction. Hence, the system 100 is unconditioned on the ground truth output 18.n for a time step when generating the predicted output 18.n at the time step. The system 100 uses the ground truth output 18.n for learning, e.g., to improve predictions at the following time step(s).

In general, an input 12 can include any type of input data, e.g., text, an image, a video, an audio waveform, a state of an agent or machine, among other types of input data. Similarly, a ground truth 14 and predicted 18 output for the input 12 can include any type of output data, e.g., a regression output, a classification output, a control input for an agent or machine, among other types of output data.

The system 100 continually generates predicted outputs 18 for the observations 10 using the neural network 110, while simultaneously updating the parameters of the neural network 110 from past observations 10, thus allowing the system 100 to adapt to non-stationarity in the data stream 102. In general, non-stationary time series data have statistical properties that change over time, e.g., means, variances, and covariances that change over time. This is contrasted with stationary time series data that have statistical properties which are invariant in time, e.g., means, variances, and covariances that do not change over time. Examples of non-stationary behavior can include, but are not limited to, trends, cycles, random walks, changes in machine learning tasks, or combinations thereof. Thus, non-stationary data is unpredictable, and typically cannot be modeled or forecasted with precision (or at all). The system 100 handles this by allowing the parameters of the neural network 110 to dynamically change at each time step in response to distributional changes that may occur in the data stream 102.

In the described examples, the neural network 110 includes: (i) a base neural network 120 that is parameterized by a set of network parameters (θ) 20, and (ii) an output network head 130 that is parameterized by a set of weights (w) 30. Here, the base neural network 120 is configured as an encoder for generating (and in some cases learning) a representation of the input 12. The output network head 130 is configured to classify the representation of the input 12 as readout.

The base neural network 120 is configured to: receive an input 12; and process the input 12, in accordance with the set of network parameters 20, to generate an embedding (z) 16 of the input 12. The operations of the base neural network 120 can be expressed as z=f(x; θ), where f is a function representing the parametric model of the base neural network 120, parameterized by the set of network parameters 20.

The base neural network 120 can have any appropriate neural network architecture that enables it to perform its described function, i.e., processing an input 12 to generate an embedding 16 of the input 12. In particular, the base neural network 120 can include any appropriate types of neural network layers (e.g., fully-connected layers, convolutional layers, recurrent layers, self-attention layers, etc.) in any appropriate numbers (e.g., 5 layers, 25 layers, or 100 layers) and connected in any appropriate configuration (e.g., as a linear sequence of layers, in residual configurations, in gated configurations, etc.).

In some implementations, the base neural network 120 is a pre-trained neural network. For example, if the input 12 is text, the base neural network 120 can be a pre-trained text encoder, e.g., a pre-trained self-attention text encoder, a pre-trained recurrent (RNN) text encoder, among others. As another example, if the input 12 is an image or a video, the base neural network 120 can be a pre-trained image or video encoder, e.g., a pre-trained CLIP image or video encoder, a pre-trained convolutional (CNN) image or video encoder, a pre-trained Visual Transformer (ViT) image or video encoder, among others. As yet another example, if the input 12 is an audio waveform, the base neural network 120 can be a pre-trained audio encoder, e.g., a pre-trained convolutional or attention-based encoder having a U-Net or Transformer architecture.

The output network head 130 is configured to: receive the embedding 16 of the input 12; and process the embedding 16 of the input 12, in accordance with the set of weights 30, to generate the predicted output 18 for the input 12. The operations of the output network head 130 can be expressed as ŷ=g(z; w), where g is a function representing the parametric model of the output network head 130, parameterized by the set of weights 30.

The output network head 130 can have any appropriate neural network architecture that enables it to perform its described function, i.e., processing an embedding 16 of an input 12 to generate a predicted output 18 for the input 12. In particular, the output network head 130 can include any appropriate types of neural network layers (e.g., fully-connected layers, convolutional layers, recurrent layers, self-attention layers, etc.) in any appropriate numbers (e.g., 5 layers, 25layers, or 100 layers) and connected in any appropriate configuration (e.g., as a linear sequence of layers, in residual configurations, in gated configurations, etc.).

In some implementations, the output network head 130 is a linear output network head, e.g., including one or more linear neural network layers. For example, the set of weights 30 parametrizing the output network head 130 can be represented as a vector of regression coefficients, such that the predicted output 18 is a (scalar) regression output ŷ=g(z; w)=w^{T}z. This representation of the output network head 130 can be utilized for a generic regression task. In another example, the set of weights 30 parametrizing the output network head 130 can be a matrix of regression coefficients, such that the predicted output 18 is a (vector) classification output ŷ=g(z; w)={wₖ^{T}z}ₖ₋₁^{K} of dimension K. This representation of the output network head 130 can be utilized for a generic classification task. Here, the classification task includes K classes where the set of weights w={wₖ}ₖ₌₁^{K} is represented as a matrix including K vectors of regression coefficients wₖ, which reduces to the univariate regression case for K=1.

In general, the system 100 reparametrizes the output network head 130 at each time step to adapt to statistical fluctuations in the data stream 102. Particularly, the system 100 employs a Markovian model over the set of weights 30 parametrizing the output network head 130, and models parameter transition (or “parameter drift”) via a transition distribution 140.n at each of the time steps:

$$p ( {w}_{n} \vert {w}_{n - 1} ; {α}_{n} ) . \qquad ( 1.1 )$$

As shown in Eq. (1.1), the transition distribution 140.n for the time step defines a conditional probability distribution over possible sets of weights 30.n for the time step, given the set of weights 30.(n−1) for the previous time step. Note, the initialization w₋₁=0 defines the prior distribution 140.0 for the initialization time step n=0:

$$p ( {w}_{0} ; {α}_{0} ) = p ( {w}_{0} \vert 0 ; {α}_{0} ) . \qquad ( 1.2 )$$

As shown in Eq. (1.2), the prior distribution 140.0 defines a probability distribution over possible sets of weights 30.0 prior the first time step in the data stream 102.

The transition distribution 140.n is parametrized by a set of distribution parameters (αₙ) 40.n that are allowed to vary at each time step in the data stream 102. This grants the system 100 considerable flexibility for adapting to non-stationarity in the data stream 102. For example, when p(wₙ|wₙ₋₁; αₙ)=δ(wₙ−wₙ₋₁) is a delta function, the system 100 reuses (or copies forward) the previous set of weights 30.(n−1). Such a situation is suitable when there is no statistical change in the data stream 102 at the n-th time step. On the other hand, when p(wₙ|wₙ₋₁; αₙ)=p(wₙ; αₙ) is independent of wₙ₋₁, the system 100 fully refreshes the set of weights 30.n unconditioned on the previous set of weights 30.(n−1), which signals a sharp statistical change in the data stream 102 at the n-th time step.

In more detail, at the initialization time step n=0, the system 100 initializes an initial set of distribution parameters (α₀) 40.0, which parametrizes the prior distribution 140.0. The system 100 then samples an initial set of weights 30.0 from the prior distribution w₀˜p(w₀; α₀). The system 100 may then parameterize the output network head 130 with the initial set of weights 30.0 in preparation for processing the data stream 102.

At each time step n>0 in the data stream 102, the system 100 obtains a set of distribution parameters (an) 40.n for the time step, which parametrizes the transition distribution 140.n for the time step. The system 100 then samples the set of weights 30.n for the time step from the transition distribution wₙ˜p(wₙ|wₙ₋₁; αₙ) and parametrizes the output network head 130 with the set of weights 30.n for the time step.

Note, for the first time step n=1 in the data stream 102, the system 100 typically initializes the first set of distribution parameters 40.1 such that w₁=w₀(or w₁≈w₀), starting with zero (or little) stochasticity in the transitions. For example, the system 100 may initialize the first set of distribution parameters 40.1 such that p(w₁|w₀; α1)=δ(w₁−w₀) is a delta function, or other sharply peaked distribution.

In implementations when the base neural network 120 is a pre-trained neural network, the system 100 can either hold the base neural network 120 frozen or fine-tune the base neural network 120 at each time step. In the frozen case, the system 100 does not update the set of network parameters 20.n parametrizing the base neural network 120, such that only the set of weights 30.nparametrizing the output network head 130 are updated. However, in the fine-tuning case, the system 100 obtains an updated set of network parameters (On) 20.n for each time step and parameterizes the base neural network 120 with the set of network parameters 20.n for the time step. The system 100 can implement a similar procedure when the base neural network 120 is not pre-trained and instead online trained from scratch. In this case, the system 100 initializes, e.g., randomly, a set of network parameters 20.1 for the first time step, and then updates them at each time step in the data stream 102. How the system 100 can online learn the sets of network parameters 20.n and distribution parameters 40.n for each time step via Bayesian filtering and SGD updates is described in more detail below.

After reparametrizing the output network head 130 (and the base neural network 120 if online trained or fine-tuned) at a time step, the system 100 then processes the input (xₙ) 12.n at the time step using the base neural network 120, in accordance with the set of network parameters 20.n for the time step, to generate an embedding (zₙ) 16.n of the input 12.n at the time step. This process can be represented concisely as zₙ=f(xₙ; θₙ), such that the embedding 16.n of the input 12.n at the time step depends on the set of network parameters 20.n parametrizing the base neural network 120.n at the time step. The system 100 then processes the embedding 16.n of the input 12.n at the time step using the output network head 130, in accordance with the set of weights 30.n for the time step, to generate the predicted output (ŷₙ) 18.n at the time step. Likewise, this process can be represented concisely as ŷₙ=g(zₙ; wₙ), such that the predicted output 18.n at the time step depends on the set of weights 30.n parametrizing the output network head 130 at the time step.

Note, the system 100 can be implemented in any appropriate location, e.g., on a user device (e.g., a mobile device), or on one or more computers in a data center, etc. Users can interact with the system 100, e.g., by providing a data stream 102 by way of an interface, e.g., a graphical user interface, or an application programming interface (API). In particular, a user can provide a user input that includes: (i) a request to process a data stream 102, and (ii) the data stream 102 to be processed by the system 100. In response to receiving the user input, the system 100 can process the data stream 102, responsive to the request, and provide multiple predicted outputs 18, e.g., as an output data steam including a corresponding one of the predicted outputs 18 at each of the time steps, e.g., for implementation on a user device of the user, or for storage in a data storage device. In some cases, the system 100 can transmit the predicted outputs 18, e.g., as the output data stream, to a user device of the user, e.g., by way of a data communication network (e.g., the internet).

### Online Bayesian Learning

In this section, the recursive Bayesian filtering algorithm the system 100 performs for online Bayesian learning is described with reference to FIGS. 1A-1C. Following this, a few select applications for regression and classification tasks are described that implement linear Gaussian models, which have exact solutions in terms of Kalman filtering equations. These implementations are particularly fast and efficient due to the analyticity of the Kalman model. For example, the computational cost can be on the order of ˜O(d²) for each time step, where d is the dimension of the base neural network 120's embedding space. For reference, a thorough review of Bayesian and Kalman filtering theory applied to more conventional engineering problems is provided by Särkkä S. Bayesian Filtering and Smoothing. Cambridge University Press (2013).

Referring now to the Bayesian filtering implemented by the system 100. Given a set of weights (wₙ) 30.n for a particular time step, and an embedding (zₙ) 16.n of the input 12.n at the time step, the system 100 models the ground truth output (yₙ) 14.n for the time step using a likelihood distribution 142.n:

$$p ( {y}_{n} \vert {w}_{n} ) = p ( {y}_{n} \vert {w}_{n} , {z}_{n} ) . \qquad ( 2.1 )$$

As shown in Eq. (2.1), the likelihood distribution 142.ₙ for the time step defines a conditional probability distribution over possible ground truth outputs 14.ₙ for the time step, given the set of weights 30.ₙ for the time step (and the embedding 16.ₙ of the input 12.ₙ at the time step).

For instance, the system 100 can model the likelihood distribution 142.ₙ for the time step as a conditional distribution over possible ground truth outputs 14.ₙ for the time step, given the state of the output network head 130 at the time step:

$$p ( {y}_{n} \vert {w}_{n} , {z}_{n} ) = p ( {y}_{n} \vert g ( {z}_{n} ; {w}_{n} ) ) . \qquad ( 2.2 )$$

As one example, the likelihood distribution 142.ₙ can be a Gaussian likelihood distribution given the state of output network head 130 at the time step:

$$p ( {y}_{n} \vert {w}_{n} , {z}_{n} ) = 𝒩 ( {y}_{n} ; g ( {z}_{n} ; {w}_{n} ) , {σ}^{2} I ) , \qquad ( 2.3 )$$

where I is the identity matrix and σ² is the variance of the ground truth outputs 14, which is assumed independent of wₙ and zₙ for simplicity.

Having specified the likelihood 142.n and transition 140.n distributions under the Markovian assumption, the full joint distribution up to the n-th time step can be written as:

$$p ( {w}_{0} ; {α}_{0} ) {\prod }_{i = 1}^{n} p ( {y}_{i} \vert {w}_{i} , {z}_{i} ) p ( {w}_{i} \vert {w}_{i - 1} ; {α}_{i} ) . \qquad ( 3 )$$

However, as computing the full joint distribution at each time step is computationally very inefficient, and generally unnecessary for online applications, the system 100 uses Bayesian filtering to track posterior distributions over each time step.

In general, to perform online learning using Bayesian filtering, the system 100 computes a predictive posterior distribution 160.n for the respective ground truth output 14.n at each time step in the data stream 102, which up to the n-th time step is represented as:

$$p ( {y}_{n} \vert {y}_{1 : n - 1} ) , \qquad ( 4.1 )$$

where y_{1:n}={y1,y₂, . . . , yₙ} and noting that p(y₁|y_{1:0})=p(y₁) at the first time step n=1. As shown in Eq. (4.1), the predictive posterior distribution 160.n for the time step defines a conditional probability distribution over possible ground truth outputs 14.n for the time step, given the ground truth output 14.(n−1,n−2, . . . , 1) at each previous time step. Nonetheless, computing the predictive posterior distribution 160.n at each time step explicitly, e.g., using full application of Bayes' rule, can be computationally intractable because the number of computations increases as the time step increases n>N. To compensate for this, the system 100 uses a recursive Bayesian filtering algorithm which performs a constant number of computations at each time step in the data stream 102.

Particularly, at each time step in the data stream 102, the system 100 preforms a prediction (inference) stage (see, FIGS. 1A-1B) followed by an update (learning) stage (see, FIG. 1C) that, after completion of the time step, results in a marginal (or “filtering”) posterior distribution 150.nfor the time step:

$$p ( {w}_{n} {y}_{1 : n} ) . \qquad ( 4.2 )$$

As shown in Eq. (4.2), the marginal posterior distribution 150.n for the time step defines a conditional probability distribution over possible sets of weights 30.n for the time step, given the ground truth output 14. (n, n−1, . . . ,1) at the time step and each previous time step.

Referring to FIGS. 1A-1B, to compute the marginal posterior distribution 150.n at each time step in the data stream 102, the system 100 first performs the prediction (inference) stage at the time step. That is, the system 100 computes a marginal predictive posterior distribution 152.n over wₙ given all observations 10.(n−1,n−2, . . . , 1) up to n−1, that is, excluding the current n-th observation 10.n. The system 100 can compute the marginal predictive posterior distribution 152.n for the time step via the Chapman-Kolmogorov equation:

$$p ( {w}_{n} \vert {y}_{1 : n - 1} ) = \int p ( {w}_{n} \vert {w}_{n - 1} ; {α}_{n} ) p ( {w}_{n - 1} \vert {y}_{1 : n - 1} ) {dw}_{n - 1} , \qquad ( 5.1 )$$

and noting that p(w₁|y_{1:0})=p(w₁) and p(w₀|y_{1:-1})=p(w₀) at the first time step n=1. As shown in Eq. (5.1), the marginal predictive posterior distribution 152.n for the time step defines a conditional probability distribution over possible sets of weights 30.n for the time step, given the ground truth output 14.(n−1,n−2, . . . ,1) at each previous time step. To compute the integral in Eq. (5.1), the system 100 obtains the marginal posterior distribution 150.(n−1) for the previous time step p(wₙ₋₁|y_{1:n-1}). The system 100 then marginalizes, with respect to the possible sets of weights 30.(n−1) for the previous time step, the transition distribution 140.n for the time step over the marginal posterior distribution 150.(n−1) for the previous time step.

The system 100 then computes the predictive posterior distribution 160.n defined in Eq. (4.1) as:

$$p ( {y}_{n} \vert {y}_{1 : n - 1} ) = \int p ( {y}_{n} \vert {w}_{n} , {z}_{n} ) p ( {w}_{n} \vert {y}_{1 : n - 1} ) {dw}_{n} . \qquad ( 5.2 )$$

Particularly, the system 100 marginalizes, with respect to the possible sets of weights 30.nfor the time step, the likelihood distribution 142.n for the time step over the marginal predictive posterior distribution 152.n for the time step.

Due to Eqs. (5.1) and (5.2), the predictive posterior distribution 160.n implicitly (or conditionally) depends on the set of distribution parameters 40.n for the time step, as well as the embedding 16.n of the input 12.n at the time step:

$$p ( {y}_{n} \vert {y}_{1 : n - 1} ) = p ( {y}_{n} \vert {y}_{1 : n - 1} , {z}_{n} ; {α}_{n} ) . \qquad ( 5.3 )$$

Thus, the predictive posterior 160.n provides a choice target for optimization and online learning the set of distribution parameters 40.n and/or the set of network parameters 20.n through zₙ=zₙ(θₙ).

Referring to FIG. 1C, after generating the predictive posterior distribution 160.n for the time step, the system 100 then performs the update (learning) stage at the time step. During the update stage, the system 100 receives the ground truth output 14.n at the time step. The system 100 then determines, from the predictive posterior distribution 160.n for the time step, a conditional probability 162.n of the ground truth output 14.n at the time step given the ground truth output 14. (n−1,n−2, . . . , 1) at each previous time step:

$$p ( {y}_{n} = {Y}_{n} \vert {y}_{1 : n - 1} ) . \qquad ( 6.1 )$$

Here, Yₙ is the particular value of the ground truth output 14.n received by the system 100 at the time step, which, as characterized by the predictive posterior 160.n, has some probability of being observed by the system 100 after observing all ground truth outputs 14 up to n−1.

The system 100 then generates an objective function 170.n for the time step that depends on the conditional probability 162.n of the ground truth output 14.n at the time step:

$$ℒ [ p ( {y}_{n} = {Y}_{n} \vert {y}_{1 : n - 1} ) ] = - log [ p ( {y}_{n} = {Y}_{n} \vert {y}_{1 : n - 1} ) ] . \qquad ( 6.2 )$$

In this example, the objective function 170.n is a loss function that includes a negative logarithm of the conditional probability 162.n. Here, the system 100 aims to maximize the conditional probability 162.n of the ground truth output 14.n under the current parameters of the system 100, e.g., such that the system 100 is likely to generate a predicted output 18.n that closely estimates the ground truth output 14.n. Particularly, the system 100 generates the next set of distribution parameters 40.(n+1) by optimizing (e.g., minimizing) the objective function 170.nwith respect to the current set of distribution parameters 40.n:

$${α}_{n + 1} = arg {min}_{{α}_{n}} ℒ [ p ( {y}_{n} = {Y}_{n} \vert {y}_{1 : n - 1} ) ] . \qquad ( 6.3 )$$

The system 100 can use various optimization techniques to optimize the objective function 170.n, e.g., stochastic gradient descent (SGD) methods such as Implicit updates, Momentum, AdaGrad, RMSProp, Adam, etc. When implementing an SGD method, the system 100 can compute a gradient of the objective function 170.n with respect to the current set of distribution parameters 40.n and subsequently apply an appropriate update rule using the gradient, e.g., with a particular learning rate and/or weight decay. For example, the system 100 can perform an SGD method by applying one or more SGD updates that change the values of an in a manner that optimizes the objective function 170.n. Schematically, the SGD update(s) can be written as:

$${α}_{n} ← {α}_{n} + {η}_{n} {∇}_{{α}_{n}} ℒ [ p ( {y}_{n} = {Y}_{n} \vert {y}_{1 : n - 1} ) ] , \qquad ( 6.4 )$$

where ηₙ is a learning rate for the time step and ∇_{α}_{ₙ} is the gradient operator with respect to the set of distribution parameters 40.n. After performing the SGD update(s) according to Eq. (6.4), the system 100 then copies the new, optimized values of αₙ into αₙ₊₁.

In some implementations, e.g., when the base neural network 120 is fine-tuned online or trained online from scratch, the system 100 also optimizes the objective function 170.n with respect to the set of network parameters 20.n. That is, the system 100 generates the set of network parameters 20.(n+1) for the next time step by (jointly) optimizing the objective function 170.n for the time step with respect to the set of network parameters 20.n for the time step:

$$( {α}_{n + 1} , {θ}_{n + 1} ) = arg {min}_{( {α}_{n} , {θ}_{n} )} ℒ [ p ( {y}_{n} = {Y}_{n} \vert {y}_{1 : n - 1} ) ] . \qquad ( 6.5 )$$

The system 100 can use the same optimization techniques as described above, e.g., SGD updates in Eq. (6.4), when (jointly) optimizing the objective function 170.n with respect to the sets of parameters 20.n and 40.n. For example, the system 100 can compute a gradient of the objective function 170.n with respect to the current set of network parameters 20.n of the base neural network 120, e.g., via backpropagation, and then apply an appropriate update rule using the gradient, e.g., with a particular learning rate and/or weight decay.

Lastly, the system 100 computes the marginal posterior distribution 150.n for the time step which is used by the system 100 at the next time step. Here, the system 100 determines, from the likelihood distribution 142.n for the time step, a conditional likelihood 164.n of the ground truth output 14.n at the time step, given the set of weights 30.n for the time step:

$$p ( {y}_{n} = {Y}_{n} \vert {w}_{n} ) . \qquad ( 7.1 )$$

The system 100 then generates, via Bayes' rule, the marginal posterior distribution 150.nfor the time step in accordance with the conditional likelihood 164.n of the ground truth output 14.n at the time step and the marginal predictive posterior distribution 152.n for the time step as:

$$p ( {w}_{n} \vert {y}_{1 : n} ) = \frac{1}{{Z}_{n}} p ( {y}_{n} = {Y}_{n} \vert {w}_{n} ) p ( {w}_{n} \vert {y}_{1 : n - 1} ) , \qquad ( 7.2 )$$

where the normalization constant (Zₙ) for the time step is given as:

$${Z}_{n} = \int p ( {y}_{n} = {Y}_{n} \vert {w}_{n} ) p ( {w}_{n} \vert {y}_{1 : n - 1} ) {dw}_{n} . \qquad ( 7.3 )$$

The system 100 performs this recursive Bayesian filter algorithm at each time step in the data stream 102 to generate the predicted outputs 18 while simultaneously updating the parameters of the neural network 110 in response to observations 10 and statistical fluctuations (non-stationarity) in the data stream 102.

### Example 1: Online Kalman Filtering for the Regression Task

In this example, exact Kalman filtering is utilized by the system 100 for a regression task. As noted above, the set of weights 30.n can be represented as a vector of regression coefficients for performing the regression task, such that the output network head 130 generates a scalar regression output g(zₙ; wₙ)=wₙ^{T}zₙ. Here, the system 100 can model the likelihood distribution 142.n as a scalar Gaussian likelihood distribution:

$$p ( {y}_{n} \vert {w}_{n} , {z}_{n} ) = 𝒩 ( {y}_{n} ; {w}_{n}^{T} {z}_{n} , {σ}^{2} ) , \qquad ( 8.1 )$$

the transition distribution 140.n as a linear Gaussian transition distribution:

$$p ( {w}_{n} {w}_{n - 1} ; {α}_{n} ) = 𝒩 ( {w}_{n} ; {γ}_{n} {w}_{n - 1} , ( 1 - {γ}_{n}^{2} ) {σ}_{w}^{2} I ) , \qquad ( 8.2 a )$$

and the prior distribution 140.0 as a Gaussian prior distribution:

$$p ( {w}_{0} ; {α}_{0} ) = 𝒩 ( {w}_{0} ; 0 , {σ}_{w}^{2} I ) , \qquad ( 8.2 b )$$

where αₙ={γₙ, σ_{w}} is the set of distribution parameters 40.n for the time step, γₙ is a “forgetting coefficient” for the time step, and σ_{w}² is a fixed variance for the set of weights 30.n. In these cases, the system 100 initializes the variance at the initialization time step n=0 and reuses it at each time step in the data stream 102. On the other hand, the forgetting coefficient γₙ is time-dependent and takes values in [0,1]. The system 100 typically initializes the forgetting coefficient as unity γ₁=1 (or close to unity γ₁≈1) for the first time step n=1 and online updates it at each time step in the data stream 102.

As its name implies, the forgetting coefficient quantifies the “memory” or “forgetting” of the output network head 130 with respect to knowledge of past observations 10 in the data stream 102. For example, when γₙ=1, then wₙ=wₙ₋₁, which means the system 100 reuses (or copies forward) the set of weights 30.(n−1) for the previous time step. Such an extreme case is suitable when there is no statistical change in the data stream 102 at the n-th time step. In the other extreme case, when γₙ=0, the system 100 fully refreshes the set of weights 30.n for the time step, i.c., resetting to the prior distribution wₙ˜p(wₙ; α₀), which signals a sharp statistical change in the data stream 102 at the n-th time step. Similarly, intermediate values of the forgetting coefficient γ_{nϵ(}0,1) can model smooth or gradual statistical changes in the data stream 102. The system 100 can flexibly learn γₙ through time using efficient Kalman filtering and SGD updates, which is described in more detail below.

It is worth mentioning that the transition distribution 140.n is analogous to a variance—preserving diffusion model, such that the set of weights 30.n for each time step follows:

$${w}_{n} = {γ}_{n} {w}_{n - 1} + \sqrt{1 - {γ}_{n}^{2}} {σ}_{w} ϵ , \qquad ( 8.3 )$$

where ϵ˜ [symbol] (0, I) is standard Gaussian noise sampled from a standard normal distribution. The forgetting coefficient γₙ may then be interpreted as a variable (or adaptive) noise schedule over the time steps in the data stream 102. Here, the system 100 can generate the set of weights 30.n at each time step by first sampling standard Gaussian noise ϵ˜ [symbol] (0, I) from a standard normal distribution. The system 100 can then increment the previous set of weights 30.(n−1) with the sampled Gaussian noise and scale the two with the forgetting coefficient γₙ and the variance σ_{w}² according to Eq. (8.3).

During the prediction (inference) stage (e.g., FIGS. 1A-1B), the system 100 can compute the marginal predictive posterior distribution 152.n analytically via a Kalman filter prediction:

$$p ( {w}_{n} \vert {y}_{1 : n - 1} ) = 𝒩 ( {w}_{n} ; {m}_{n}^{{}_{-}} {A}_{n}^{-} ) , \qquad ( 8.4 )$$

where mₙ⁻ is the mean vector and An is the covariance matrix of the marginal predictive posterior distribution 152.n for the time step:

$${m}_{n}^{{}_{-}} = {γ}_{n} {m}_{n - 1} , {A}_{n}^{-} = {γ}_{n}^{2} {A}_{n - 1} + ( 1 - {γ}_{n}^{2} ) {σ}_{w}^{2} I . \qquad ( 8.5 )$$

Here, mₙ₋₁ is the mean vector and Aₙ₋₁ is the covariance matrix of the marginal posterior distribution 150.(n−1) for the previous time step. The system 100 can also compute the predictive posterior distribution 160.n analytically as:

$$p ( {y}_{n} \vert {y}_{1 : n - 1} ) = 𝒩 ( {y}_{n} ; {z}_{n}^{⊤} {m}_{n}^{{}_{-}} , {z}_{n}^{⊤} {A}_{n}^{-} {z}_{n} + {σ}^{2} ) . \qquad ( 8.6 )$$

During, the update (learning) stage (e.g., FIG. 1C), the system 100 can then generate the objective function 170.n as:

$$ℒ [ p ( {y}_{n} = {Y}_{n} \vert {y}_{1 : n - 1} ) ] = - log [ 𝒩 ( {y}_{n} = {Y}_{n} ; {z}_{n}^{⊤} {m}_{n}^{{}_{-}} , {z}_{n}^{⊤} {A}_{n}^{-} {z}_{n} + {σ}^{2} ) ] = log \sqrt{2 π ( {z}_{n}^{⊤} {A}_{n}^{-} {z}_{n} + {σ}^{2} )} + \frac{{( {y}_{n} - {z}_{n}^{⊤} {m}_{n}^{{}_{-}} )}^{2}}{2 ( {z}_{n}^{⊤} {A}_{n}^{-} {z}_{n} + {σ}^{2} )} , \qquad ( 8.7 )$$

which is a tractable loss function that can be optimized fast and efficiently by the system 100. Particularly, the system 100 optimizes the objective function 170.n with respect to the forgetting coefficient (γₙ), where the objective function 170.n is dependent on γₙ through mₙ⁻ and Aₙ⁻. The system 100 then copies the new, optimized value of γₙ into γₙ₊₁ for the next time step. Note, the system 100 may further parameterize the forgetting coefficient as γₙ=exp(−δₙ/2), with δₙ≥0, so that the optimization is performed with respect to δₙ.

In a similar fashion as the marginal predictive posterior distribution 152.n, the system 100 can compute the marginal posterior distribution 150.n analytically using a Kalman filter update as:

$$p ( {w}_{n} \vert {y}_{1 : n} ) = 𝒩 ( {w}_{n} ; {m}_{n} , {A}_{n} ) , \qquad ( 8.8 )$$

where mₙ is the mean vector and Aₙ is the covariance matrix of the marginal posterior distribution 150.n that are updated from mₙ⁻ and Aₙ⁻ to incorporate the information arriving from the most recent observation 10.n. This is implemented in terms of zₙ and yₙ as:

$${m}_{n} = {m}_{n}^{{}_{-}} + \frac{{A}_{n}^{-} {z}_{n} ( {y}_{n} - {z}_{n}^{⊤} {m}_{n}^{{}_{-}} )}{{z}_{n}^{⊤} {A}_{n}^{-} {z}_{n} + {σ}^{2}} , {A}_{n} = {A}_{n}^{-} - \frac{{A}_{n}^{-} {z}_{n} {z}_{n}^{⊤} {A}_{n}^{-}}{{z}_{n}^{⊤} {A}_{n}^{-} {z}_{n} + {σ}^{2}} , \qquad ( 8.9 )$$

with the initialization m₀=0 and A₀=σ_{w}²I. Here, the computational cost per time step is ˜O(d²), where d is the size of wₙ and zₙ, which means the Kalman recursions are computationally very efficient.

### Example 2: Online Kalman Filtering for the Classification Task

In this example, exact Kalman filtering is utilized by the system 100 for a classification task. As noted above, the set of weights 30.n can represented as a matrix of regression coefficients wₙ={w_{n,k}}ₖ₌₁^{K} for preforming the classification task, such that the output network head 130 generates a vector classification output g(zₙ; wₙ)={w_{n,k}^{T}z}ₖ₌₁^{K} of dimension K. Here, the system 100 models the likelihood distribution 142.n as a softmax likelihood distribution:

$$p ( {y}_{n , k} = 1 \vert {w}_{n} , {z}_{n} ) = \frac{exp ( {w}_{n , k}^{⊤} {z}_{n} )}{{\sum }_{j = 1}^{K} exp ( {w}_{n , j}^{⊤} {z}_{n} )} , \qquad ( 9.1 )$$

where yₙ={y_{n,k}}ₖ₌₁^{K} is represented as a K-dimensional one-hot vector, i.e., yₙ∈{0,1}^{K} and Σₖ₌₁^{K}y_{n,k}=1. However, exact online inference over the set of weights 30.n using Kalman recursions is generally intractable due to the non-Gaussian form of the softmax likelihood. In these cases, the system 100 can rely on approximate inference, that still uses exact Kalman recursions, by introducing a Gaussian likelihood that approximates the softmax likelihood via a product of respective Gaussians for each k∈K:

$$p ( {y}_{n} \vert {w}_{n} , {z}_{n} ) = {\prod }_{k = 1}^{K} 𝒩 ( {y}_{n , k} ; {w}_{n , k}^{⊤} {z}_{n} , {σ}^{2} ) . \qquad ( 9.2 )$$

With the approximate likelihood distribution 142.n in Eq. (9.2), the Kalman recursions remain tractable for the classification task. Again, the system 100 models the transition distribution 140.n as a linear Gaussian transition distribution according to Eq. (8.2). Particularly, each weight vector w_{n,k} of the set of weights 30.n follows an independent Markov process according to Eq. (8.2), such that each k-th weight vector is independent from the other weight vectors, but has a respective transition distribution 140.n parametrized by a common forgetting coefficient γₙ and variance σ_{w}².

Due to the approximate Gaussian likelihood 142.n of Eq. (9.2), the system 100 can compute the marginal predictive posterior distribution 152.n analytically using a Kalman filter prediction as:

$$p ( {w}_{n} \vert {y}_{1 : n} ) = {\prod }_{k = 1}^{K} 𝒩 ( {w}_{n , k} ; {m}_{n , k}^{{}_{-}} , {A}_{n}^{-} ) , \qquad ( 9.3 )$$

where mₙ⁻={m_{n,k}⁻}ₖ₌₁^{K} is the matrix of mean vectors and Aₙ⁻ is the covariance matrix of the marginal predictive posterior distribution 152.n for the time step:

$${m}_{n}^{{}_{-}} = {γ}_{n} {m}_{n - 1} , {A}_{n}^{-} = {γ}_{n}^{2} {A}_{n - 1} + ( 1 - {γ}_{n}^{2} ) {σ}_{w}^{2} I . \qquad ( 9.4 )$$

Here, mₙ₋₁={m_{n-1,k}}ₖ₌₁^{K} is the matrix of mean vectors and Aₙ₋₁ is the covariance matrix of the marginal posterior distribution 150.(n−1) for the previous time step. Along similar lines, the system 100 can compute the marginal posterior distribution 150.n analytically using a Kalman filter update as:

$$p ( {w}_{n} \vert {y}_{1 : n} ) = {\prod }_{k = 1}^{K} 𝒩 ( {w}_{n} ; {m}_{n , k} , {A}_{n} ) . \qquad ( 9.5 )$$

where mₙ={m_{n,k}}ₖ₌₁^{K} is the matrix of mean vectors and Aₙ is the covariance matrix of the marginal posterior distribution 150.n for the time step. These are updated from mₙ⁻ and Aₙ⁻ to incorporate the information arriving from the most recent observation 10.n, which is implemented in terms of zₙ and yₙ as:

$${m}_{n} = {m}_{n}^{{}_{-}} + \frac{{A}_{n}^{-} {z}_{n} ( {y}_{n}^{⊤} - {z}_{n}^{⊤} {m}_{n}^{{}_{-}} )}{{z}_{n}^{⊤} {A}_{n}^{-} {z}_{n} + {σ}^{2}} , {A}_{n} = {A}_{n}^{-} - \frac{{A}_{n}^{-} {z}_{n} {z}_{n}^{⊤} {A}_{n}^{-}}{{z}_{n}^{⊤} {A}_{n}^{-} {z}_{n} + {σ}^{2}} , \qquad ( 9.6 )$$

with the initialization m₀={0} and A₀=σ_{w}²I. Here, the computational cost per time step is ˜O(Kd+d²). If the size d of the embedding space is larger than the number of classes K, the term ˜O(d²) dominates and the complexity is the same as in univariate regression K=1. The reason the system 100 can realize such efficiency is because the covariances matrices (Aₙ⁻, Aₙ) are shared among all K classes, which is a result of the hyperparameter σ² being shared among all K classes in the approximate Gaussian likelihood of Eq. (9.2).

Note, the Kalman recursion may be viewed as an approximate online inference procedure that provides an estimate to the exact, intractable marginal posterior distribution 150.n, e.g., obtained via Bayes' rule with the exact softmax likelihood 142.n of Eq. (9.1). However, when the system 100 predicts class probabilities or computes a loss to optimize the network parameters 20.n and/or distribution parameters 40.n, the system 100 can combine the approximate marginal predictive posterior 152.n of Eq. (9.3) with the exact softmax likelihood 142.n of Eq. (9.1) via Bayesian averaging and Monte Carlo estimation. For example, the system 100 can approximate the predictive posterior distribution 160.n for the time step by performing a Monte Carlo estimation over the possible sets of weights 30.n for the time step:

$$p ( {y}_{n , k} = 1 \vert {y}_{1 : n - 1} ) \approx \frac{1}{S} {\sum }_{s = 1}^{S} \frac{exp ( {m}_{n , k}^{- ⊤} {z}_{n} + {z}_{n}^{⊤} {A}_{n}^{-} {z}_{n} {ϵ}_{k}^{( s )} )}{{\sum }_{j = 1}^{K} exp ( {m}_{n , j}^{- ⊤} {z}_{n} + {z}_{n}^{⊤} {A}_{n}^{-} {z}_{n} {ϵ}_{j}^{( s )} )} , \qquad ( 9.7 )$$

with ϵ^{(s)}˜ [symbol] (0,I) and S is the number of samples in the Monte Carlo estimation. To move from Eq. (5.2) to (9.7), the system 100 first reparametrizes the integral to be an expectation under the standard normal distribution and then applies Monte Carlo.

However, given that the predictive posterior distribution 160.n of Eq. (9.7) approximates the true predictive posterior distribution, the log predictive probability of Eq. (6.2) can be inaccurate. The system 100 can improve this estimate by fine-tuning over a calibration parameter that is optimized with SGD update steps. Particularly, for the calibration procedure, the system 100 introduces a calibration parameter β>0 that rescales the logits inside the softmax function of Eq. (9.7), so that the final Monte Carlo estimate becomes:

$$p ( {y}_{n , k} = 1 \vert {y}_{1 : n - 1} ) \approx \frac{1}{S} {\sum }_{s = 1}^{S} \frac{exp ( β {m}_{n , k}^{- ⊤} {z}_{n} + β {z}_{n}^{⊤} {A}_{n}^{-} {z}_{n} {ϵ}_{k}^{( s )} )}{{\sum }_{j = 1}^{K} exp ( β {m}_{n , j}^{- ⊤} {z}_{n} + β {z}_{n}^{⊤} {A}_{n}^{-} {z}_{n} {ϵ}_{j}^{( s )} )} . \qquad ( 9.8 )$$

The system 100 can optimize β and θ jointly with online SGD steps, that is, as individual observations 10.n arrive sequentially.

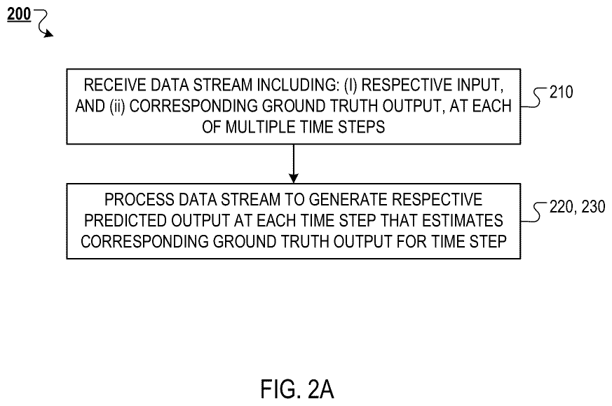

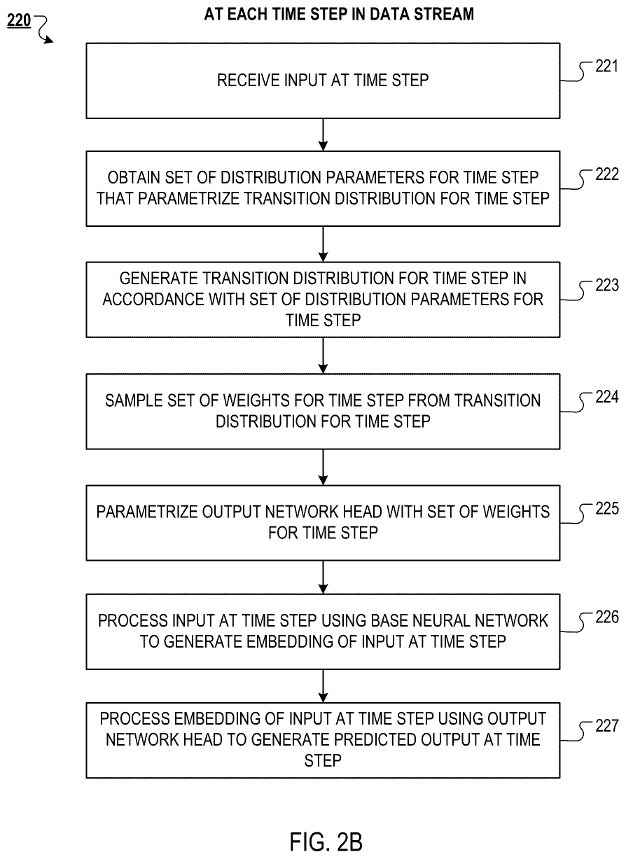

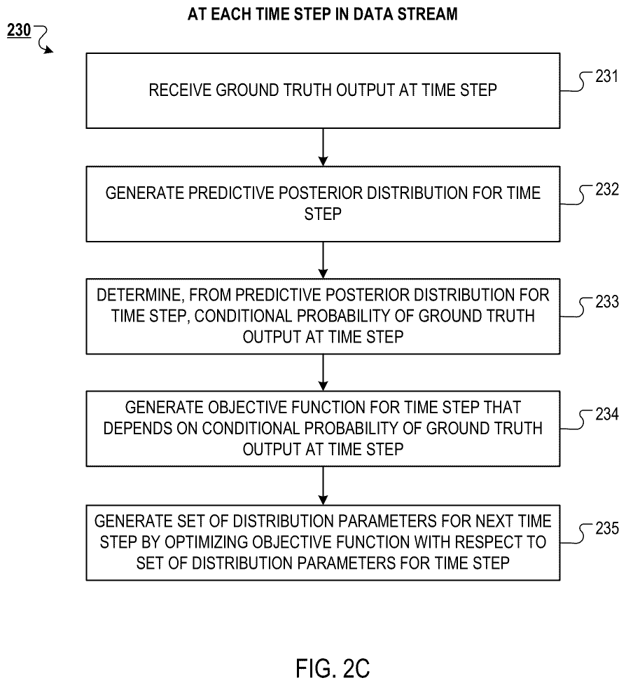

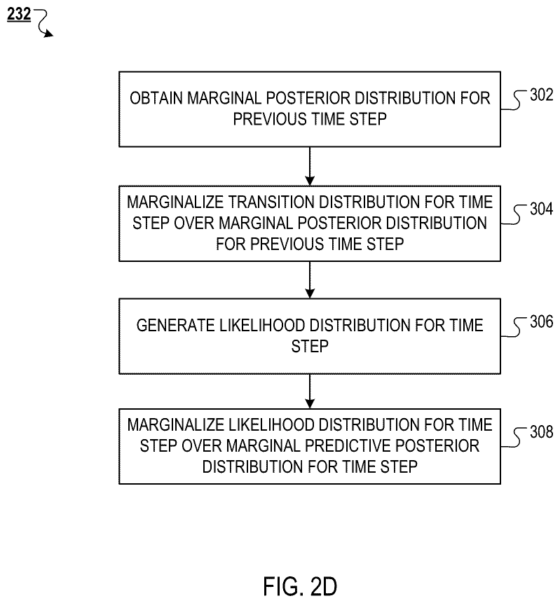

FIGS. 2A-2D are flow diagrams of an example process 200 for performing online inference and learning on a data stream 102 using the neural network 110 and probabilistic Bayesian filtering. For convenience, the process 200 will be described as being performed by a system of one or more computers located in one or more locations. For example, an online inference and learning system, e.g., the online inference and learning system 100 of FIGS. 1A-1C, appropriately programmed in accordance with this specification, can perform the process 200.

The process 200 may briefly begin, e.g., at an initialization time step n=0, with the system 100 initializing an initial set of distribution parameters 40.0 that parametrizes a prior distribution 140.0. The prior distribution 140.0 defines a probability distribution over possible sets of weights 30.0 prior to a first time step in the data stream 102.

The system 100 can then generate the prior distribution 140.0 in accordance with the initial set of distribution parameters 40.0 and sample an initial set of weights 30.0 from the prior distribution 140.0. The system 100 may then parametrize the output network head 130 with the initial set of weights 30.0 in preparation for processing the data stream 102.

The system 100 can also initialize a set of distribution parameters 40.1 for the first time step that parametrizes a transition distribution 140.1 for the first time step. The transition distribution 140.1 for the first time step defines a conditional probability distribution over possible sets of weights 30.1 for the first time step, given the initial set of weights 30.0 prior the first time step.

In some implementations, the system 100 also initializes a set of network parameters 20.1 for the first time step. For example, the system 100 can initialize the set of network parameters 20.1 for the first time step as a random set of network parameters, e.g., if the base neural network 120 is online trained from scratch over the data stream 102. As another example, the system 100 can initialize the set of network parameters 20.1 for the first time step as a pre-trained set of network parameters, e.g., if the neutral network 120 is fixed or online fine-tuned over the data stream 102.

Referring to FIG. 2A showing a flow diagram of the process 200 for performing online inference and learning on the data stream 102.

The system 100 receives the data stream 102 that includes: (i) a respective input 12.n, and (ii) a corresponding ground truth output 14.n, at each of multiple time steps (210).

The system 100 processes the data stream 102 to generate a respective predicted output 18.n at each time step that estimates the corresponding ground truth output 14.n for the time step (220, 230).

Referring to FIG. 2B showing a flow diagram of an example process 220 for performing online inference on the data stream 102.

At each time step (n=1,2, . . . , N) in the data stream 102:

The system 100 receives the input 12.n at the time step (221).

The system 100 obtains a set of distribution parameters 40.n for the time step that parametrizes a transition distribution 140.n for the time step (222). The transition distribution 140.n for the time step defines a conditional probability distribution over possible sets of weights 30.n for the time step, given a set of weights 30.(n−1) for a previous time step.

The system 100 generates the transition distribution 140.n for the time step in accordance with the set of distribution parameters 40.n for the time step (223).

The system 100 samples a set of weights 30.n for the time step from the transition distribution 140.n for the time step (224).

The system 100 parametrizes the output network head 130 with the set of weights 30.n for the time step (225).

In some implementations of the process 220, the system 100 also obtains a set of network parameters 20.n for the time step and parameterizes the base neural network 120 with the set of network parameters 20.n for the time step.

The system 100 processes the input 12.n at the time step using the base neural network 120, in accordance with the set of network parameters 20.n for the time step to generate an embedding 16.n of the input 12.n at the time step (226).

The system 100 process the embedding 16.n of the input 12.n at the time step using the output network head 130, in accordance with the set of weights 30.n for the time step, to generate the predicted output 18.n at the time step (227).

Referring to FIG. 2C showing a flow diagram of an example process 230 for performing online learning on the data stream 102.

At each time step (n=1,2, . . . , N) in the data stream 102:

The system 100 receives the ground truth output 14.n at the time step (231).

The system 100 generates a predictive posterior distribution 160.n for the time step that depends on: (i) the set of distribution parameters 40.n for the time step, and (ii) the embedding 16.n of the input 12.n at the time step (232). The predictive posterior distribution 160.n for the time step defines a conditional probability distribution over possible ground truth outputs 14.n for the time step, given the ground truth output 14.(n−1,n−2, . . . 1) at each previous time step.

The system 100 determines, from the predictive posterior distribution 160.n for the time step, a conditional probability 162.n of the ground truth output 14.n at the time step, given the ground truth output 14.(n−1, n−2, . . . 1) at each previous time step (233).

The system 100 generates an objective function 170.n for the time step that depends on the conditional probability 162.n of the ground truth output 14.n at the time step (234).

The system 100 generates a set of distribution parameters 40.(n+1) for a next time step by optimizing the objective function 170.n for the time step with respect to the set of distribution parameters 40.n for the time step (235).

In some implementations of the process 230, the system 100 also generates a set of network parameters 20.(n+1) for the next time step by (e.g., jointly) optimizing the objective function 170.n for the time step with respect to the set of network parameters 20.n for the time step.

Referring to FIG. 2D showing a flow diagram of the process 232 for generating the predictive posterior distribution 160.n for the time step.

The system 100 obtains a marginal posterior distribution 150.(n−1) for the previous time step (302). The marginal posterior distribution 150.(n−1) for the previous time step defines a conditional probability distribution over possible sets of weights 30.(n−1) for the previous time step, given the ground truth output 14.(n−1,n−2, . . . 1) at each previous time step.

To generate a marginal predictive posterior distribution 152.n for the time step, the system 100 marginalizes, with respect to the possible sets of weights 30.(n−1) for the previous time step, the transition distribution 140.n for the time step over the marginal posterior distribution 150.(n−1) for the previous time step (304).

The system 100 generates a likelihood distribution 142.n for the time step that depends on the embedding 16.n of the input 12.n at the time step (306). The likelihood distribution 142.n for the time step defines a conditional probability distribution over possible ground truth outputs 14.n for the time step, given the set of weights 30.n for the time step.

To generate the predictive posterior distribution 160.n for the time step, the system 100 marginalizes, with respect to the possible sets of weights 30.n for the time step, the likelihood distribution 142.n for the time step over the marginal predictive posterior distribution 152.n for the time step (308).

In some implementations of the process 308, the system 100 performs a Monte Carlo estimation over the possible sets of weights 30.n for the time step.

In some implementations of the process 230, the system 100 also generates a marginal posterior distribution 150.n for the time step. The marginal posterior distribution 150.n for the time step defines a conditional probability distribution over possible sets of weights 30.n for the time step, given the ground truth output 14.(n,n−1, . . . 1) at the time step and each previous time step.

To do so, the system 100 determines, from the likelihood distribution 142.n for the time step, a conditional likelihood 164.n of the ground truth output 14.n at the time step, given the set of weights 30.n for the time step.

The system 100 then generates, via Bayes' rule, the marginal posterior distribution 150.n for the time step in accordance with the conditional likelihood 164.n of the ground truth output 14.n at the time step and the marginal predictive posterior distribution 152.n for the time step.

Algorithm 1 below is an example implementation of the process 200 for online inference and learning using the neural network 110 and probabilistic Kalman filtering, e.g., using exact Kalman filter recursions for a regression or classification task. As shown in Algorithm 1, since Kalman filtering is analytic, the system 100 can avoid direct computations of the probability distributions, e.g., via marginalization and Bayes' rule, and instead update the parameters of the probability distributions via fast Kalman recursions.

Algorithm 1: Kalman Online Inference and Learning

| Data: (xₙ, yₙ)_{n≥1} | |
|---|---|
| Result: {ŷₙ}_{n≥1} with ŷₙ ≈ yₙ | |
| m₀ = {0}; | |
| A_{θ} = σ_{w}²I; | |
| w₀ = σ_{w}ϵ; | |
| (γ₁, θ₁) = (γ₀, θ₀), e.g., γ_{θ} = 1 and θ₀ is pre-trained or randomly | |
| initialized; | |
| (Optionally) parametrize γ₀ = exp(−δₙ/2); | |
| for n = 1, 2, 3, . . . , do | |
| \| | Obtain parameters (γ₀, θₙ); |
| \| | Obtain predictive Kalman statistics: mₙ⁻ = γₙmₙ₋₁ and |
| \| | Aₙ⁻ = γₙ²Aₙ₋₁ + (1 − γₙ²)σ_{w}²; |
| \| | Sample noise ϵ~ [symbol] (0, I), generate weights |
| \| | wₙ = γₙwₙ₋₁ + \sqrt{1 − γₙ²}σ_{w}ϵ, and |
| \| | parametrize output network head g = g(z; wₙ); |
| \| | Parmetrize base neural network f = f(z; θₙ); |
| \| | Observe input xₙ; |
| \| | Compute embedding zₙ = f(xₙ; θₙ) and predict output. |
| \| | ŷₙ = y(zₙ; wₙ); |
| \| | Observe ground truth output yₙ; |
| \| | Update parameters (γₙ₊₁, θₙ₊₁) = arg min_{(γ}_{ₙ}_{,θ}_{ₙ}₎ |
| | [symbol] (zₙ, yₙ, mₙ⁻, Aₙ⁻); |
| \| | Update Kalman statistics: |
| \| \| \| \| | $\begin{matrix}{m}_{n} = {m}_{n}^{-} + \frac{{A}_{n}^{-} {z}_{n}}{z \text{?} {A}_{n}^{-} {z}_{n} + σ \text{?}} ( {y}_{n}^{⊤} - {z}_{n}^{⊤} {m}_{n}^{-} ) and \\ {A}_{n} = {A}_{n}^{-} - \frac{{A}_{n}^{-} \text{?} {A}_{n}^{-}}{z \text{?} {A}_{n}^{-} {z}_{n} + σ \text{?}} ;\end{matrix}$ |
| end | |

$\text{?} \text{indicates text missing or illegible when filed}$

### Experiment 1: Online Regression on Time Series Data

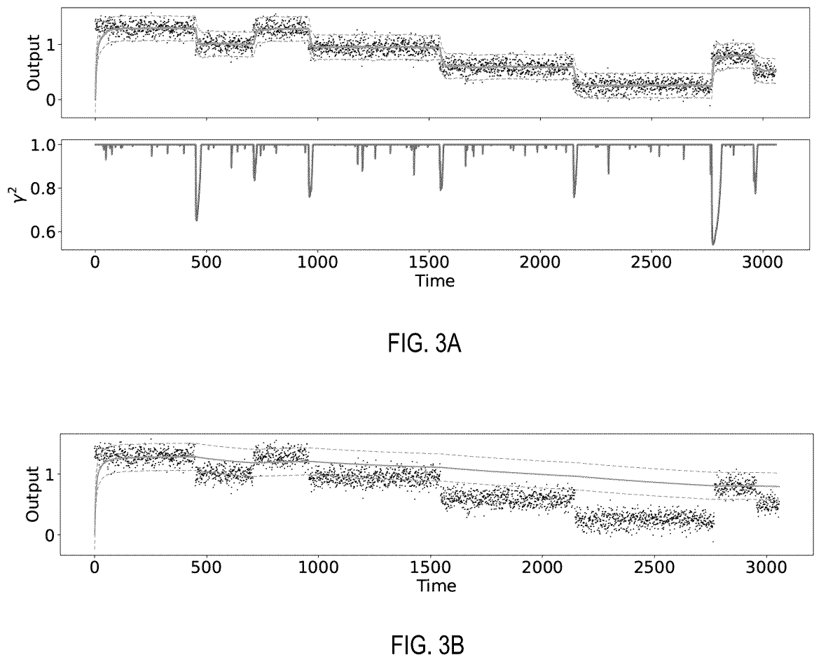

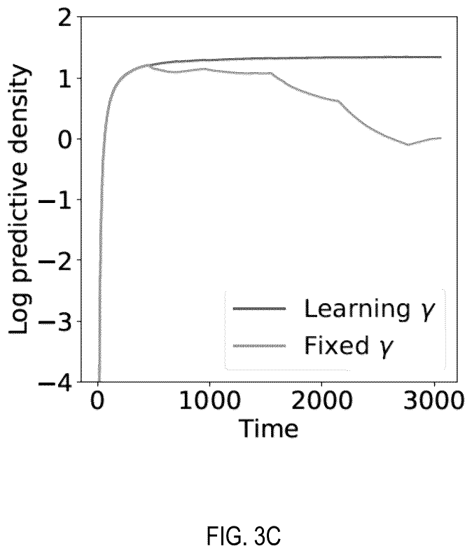

FIGS. 3A-3C are experimental plots showing results of an experiment that was performed by example configurations of the system 100 for tracking an artificial, non-stationary data stream. The top plot in FIG. 3A shows the data (dots) and the predicted mean and uncertainty (lines) over γₙ as data arrived sequentially from left to right. The bottom plot in FIG. 3A shows the optimized values of γₙ²=exp(−δₙ). FIG. 3B shows online prediction on the artificial data stream when the forgetting coefficient was fixed to γₙ=1. FIG. 3C shows the accumulated average log predictive density 1/n Σᵢ₌₁ⁿ log p(γᵢ|γ_{1:i-1}) computed across time for the model that learned γₙ and the model that ignored non-stationarity by setting γₙ=1 for all n.

More particularly, the regression task for the system 100 was to track the artificial, non-stationary data stream, which included scalar, noisy ground truth outputs y ₙ, without any conditioning inputs xₙ. The embedding was a univariate constant value equal to unity zₙ=1, so the likelihood simplified to p(yₙ|wₙ)= [symbol] (yₙ; wₙ, σ²) and the weight parameter wₙ, that was inferred through time, modelled the unknown expected value of yₙ. The top plot of FIG. 3A shows the results of the Kalman model that was initialized with γ₀=1 and learned online. The non-stationary nature of the data stream was such that the signal was piecewise (noisy) constant with seven change-points. As shown in the bottom plot of FIG. 3A, the learned value of γₙ was able to adjust to this non-stationarity by dropping below a value of one, e.g., to refresh the Bayesian statistics over wₙ, any time there was a change-point. In contrast, as shown in the plot of FIG. 3B, when the ability to capture non-stationarity was removed, i.e., by setting γₙ=1 for all n, the performance reduced sustainably, as shown by the accumulated log predictive density scores in FIG. 3C.

### Experiment 2: Online Classification on CIFAR-100

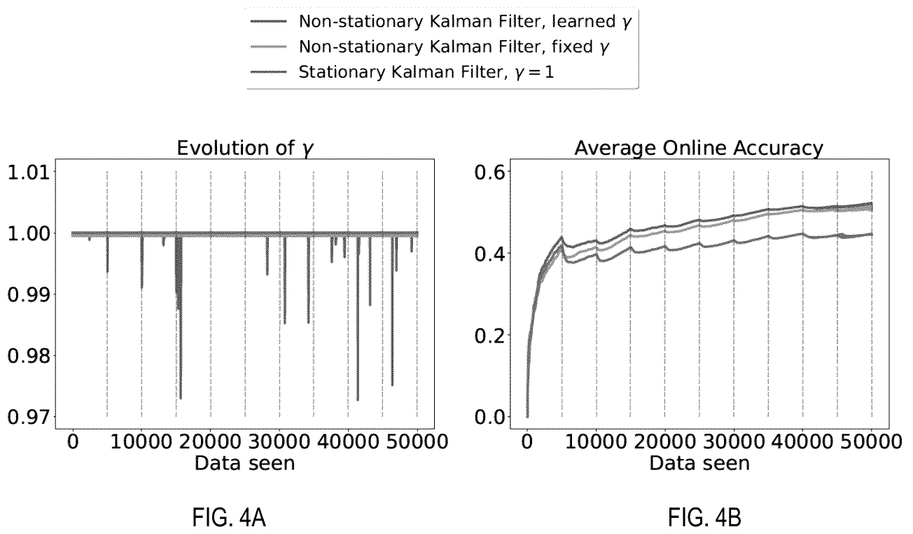

FIGS. 4A-4B are experimental plots showing results of an experiment that was performed by example configurations of the system 100 for online classification on CIFAR-100. FIG. 4A is a plot showing the evolution of γ, and FIG. 4B is a plot showing the corresponding average online accuracy. The dashed lines in FIGS. 4A-4B correspond to task boundaries.

The performance of the system 100 was evaluated on two variants of online classification on CIFAR-100: (i) stationary online classification on CIFAR-100, and (ii) non-stationary online classification on CIFAR-100. In the stationary case, the data stream was constructed by randomly shuffling the CIFAR-100 dataset. Since it was randomly shuffled, there was no non-stationarity. In the non-stationary case, a task-agnostic class-incremental version of Split-CIFAR-100 was implemented, where CIFAR-100 was split into ten tasks, each containing ten different classes, and concatenated into a data stream. In this setting, there was distinct non-stationarity related to the task changes.

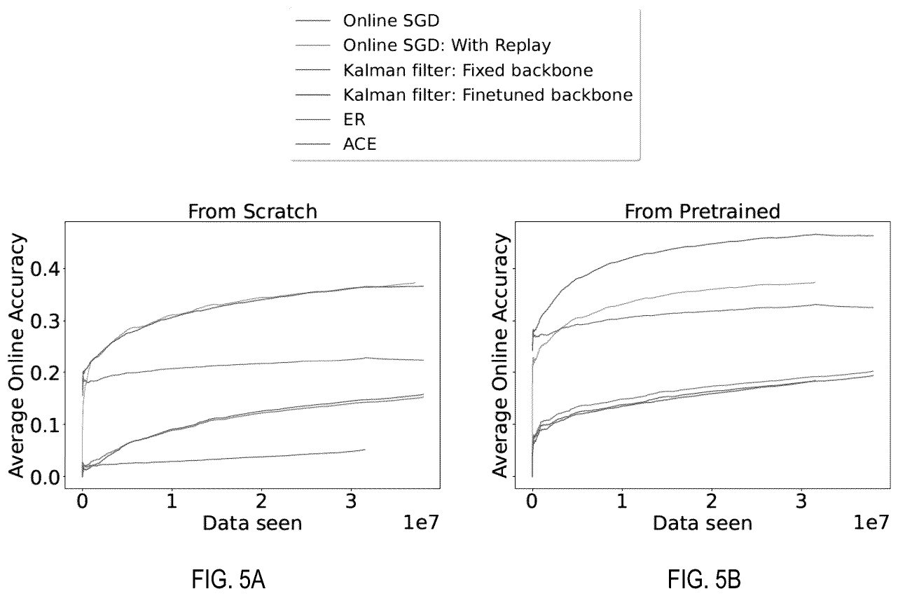

Multiple Kalman filter configurations of the system 100 were experimented: (i) a Stationary Kalman Filter (γ=1), (ii) a Non-stationary Kalman Filter with fixed γ=0.999, and (iii) a Non-stationary Kalman Filter with learned γ. In addition, the Kalman filters were experimented in three regimes for the base neural network 120: (i) no base neural network finetuning, a regime with fixed, randomly initialized embeddings (z), (ii) base neural network finetuning, and base neural network finetuning with replay. As baselines, the Kalman filters were compared against ACE, ER, and ER++. The results are provided in Table 1 below. The external baseline results for the CIFAR-100 experiment (as well as for the CLOC experiment described below with reference to FIGS. 5A-5B) are reproduced herein from Ghunaim, Yasir, et al., “Real-time evaluation in online continual learning: A new hope,” Proceedings of the IEEE/CVF Conference on Computer Vision and Pattern Recognition (2023).

In the stationary CIFAR-100 case, the stationary Kalman filter provided reasonable performance and was generally better than the non-stationary Kalman filter with fixed y. This is consistent with there being little non-stationarity to model. The Kalman Filter with learned y lead to slightly better results than the stationary case. Moreover, the replay-free Kalman filter led to competitive results against external baselines. Adding replay to Kalman improved results even further, beating ER++ baseline which uses much more replay than ER.

In the non-stationary CIFAR-100 case, the stationary Kalman filter performed consistently worse than its non-stationary variants. This is consistent with there being specific non-stationarity that the Kalman filter could capture. Moreover, the results show that learning γ generally leads to better performance. FIGS. 4A-4B visualize the dynamics of learning γ for the Base Network Finetuning setting, with dashed lines indicating task boundaries. In many cases, γ dropped at task boundaries, in effect pushing down probabilities of classes from previous classes and focusing on future data.

TABLE 1
CIFAR-100 results in stationary and non-stationary settings.
The numbers in bold correspond to the best performing
method in the group. The amount
of replay used for Kalman filter was similar to ER baseline.

| | Average Online Accuracy | |
|---|---|---|
| | Stationary | Non-stationary |
| Method | CIFAR-100 | CIFAR-100 |
| No base network finetuning | | |
| (purely linear model) | | |
| Stationary Kalman Filter (γ = 1) | 10.9% | 12.1% |
| Non-stationary Kalman Filter | 9.2% | 31.9% |
| (fixed γ = 0.999) | | |
| Non-stationary Kalman Filter (learned) | 11.4% | 32.7% |
| Base network finetuning | | |
| Stationary Kalman Filter (γ = 1) | 16.4% | 44.5% |
| Non-stationary Kalman Filter | 15.9% | 50.5% |
| (fixed γ = 0.999) | | |
| Non-stationary Kalman Filter (learned) | 16.9% | 51.2% |
| Base network finetuning with Replay | | |
| Stationary Kalman Filter (γ = 1) | 18.5% | 51.6% |
| Non-stationary Kalman Filter | 18.9% | 55.5% |
| (fixed γ = 0.999) | | |
| Non-stationary Kalman Filter (learned) | 19.0% | 55.5% |
| External Baselines | | |
| ACE | 14.42% | — |
| ER | 13.62% | — |
| ER++ | 18.45% | — |

### Experiment 3: Online Classification on CLOC

FIGS. 5A-5B are experimental plots showing results of an experiment that was performed by example configurations of the system 100 for online classification on CLOC. FIG. 5A shows the results when the base neural network was trained online from scratch. FIG. 5B shows the results when the base neural network was a pre-trained neural network. Results are also reported for ER and ACE external baselines with models trained from scratch and pretrained models. Note, in FIG. 5A, the top two curves that are on top of each other are Online SGD with replay and Kalman filter with a fine-tuned base neural network. However, as shown in FIG. 5B, Kalman filter with a fine-tuned base neural network outperformed Online SGD considerably when the base neural network was pre-trained.

In CLOC, each image in a chronological data-sequence is associated with the geographical location where it was taken, discretized to 713 (balanced) classes. CLOC is a highly non-stationary task on multiple overlapping timescales because, e.g., major sports events lead to busts of photos from certain locations, seasonal changes effect the appearance of landmarks, locations change popularity over time, etc. The version of CLOC and Online SGD (baseline model) used in the experiment were the same as those described in Bornschein, Jorg, Yazhe Li, and Marcus Hutter, “Sequential Learning of Neural Networks for Prequential MDL,” arXiv preprint arXiv: 2210.07931 (2022). About 5% of the images could not be downloaded or decoded which resulted in a sequence of 37,093,769 images.

The experiment involved a ResNet-50 base neural network. For the Kalman filter, a variant with learned y was implemented, which performed better than any fixed one, including γ=1. In the experiments, the base neural network was either fixed or fine-tuned. The case of a fixed base neural network corresponded to a linear model. The experiments were run with either learning on CLOC from scratch or starting with an ImageNet-pretrained base neural network that was pre-trained via supervised loss. As baselines, Online SGD with and without replay, ER, and ACE were used as comparative examples. The results are shown in FIGS. 5A-5B. As shown, the Kalman filter exhibited strong performance compared to the baselines. When learning from scratch, replay-free Kalman filter matched the performance of Online SGD with replay. This is a notable result as the Kalman filter did (and generally does not) need to store additional data in memory. Moreover, even the Kalman filter with fixed base neural network performed better than online SGD. When starting from the pre-trained base neural network, the Kalman filter learned more efficiently than any of the baselines. In general, this demonstrates the strong capabilities of the system 100 for performing large-scale non-stationary learning.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for online inference involving a neural network comprising a base neural network and an output network head, wherein the method comprises:
receiving a data stream comprising a respective input at each of a plurality of time steps; and
processing the data stream to generate a respective predicted output at each time step that estimates a corresponding ground truth output for the time step, comprising, at each time step:
receiving the input at the time step;
obtaining a set of distribution parameters for the time step that parametrizes a transition distribution for the time step,
wherein the transition distribution for the time step defines a conditional probability distribution over possible sets of weights for the time step, given a set of weights for a previous time step;
generating a set of weights for the time step using the set of distribution parameters for the time step;
parametrizing the output network head with the set of weights for the time step; and
processing the input at the time step using the neural network to generate the predicted output at the time step, comprising:
processing the input at the time step using the base neural network to generate an embedding of the input at the time step; and
processing the embedding of the input at the time step using the output network head, in accordance with the set of weights for the time step, to generate the predicted output at the time step.

2. The method of claim 1, wherein at each time step:
the transition distribution for the time step is a linear Gaussian transition distribution, and
the set of distribution parameters for the time step comprises a forgetting coefficient for the time step.

3. The method of claim 2, wherein at each time step:
the linear Gaussian transition distribution for the time step is variance-preserving, and
the set of distribution parameters for the time step consists of: (i) the forgetting coefficient for the time step, and (ii) a fixed variance.

4. The method of claim 1, wherein at each time step, generating the set of weights for the time step using the set of distribution parameters for the time step comprises:
generating the transition distribution for the time step in accordance with the set of distribution parameters for the time step; and
sampling the set of weights for the time step from the transition distribution for the time step.

5. The method of claim 1, wherein:
the data stream further comprises the respective ground truth output at each time step, and processing the data stream further comprises, at each time step:
receiving the ground truth output at the time step; and
generating a set of distribution parameters for a next time step using: (i) the set of distribution parameters for the time step, (ii) the embedding of the input at the time step, and (iii) the ground truth output at the time step.

6. The method of claim 5, wherein at each time step, generating the set of distribution parameters for the next time step comprises:
generating a predictive posterior distribution for the time step that depends on: (i) the set of distribution parameters for the time step, and (ii) the embedding of the input at the time step,
wherein the predictive posterior distribution for the time step defines a conditional probability distribution over possible ground truth outputs for the time step, given the ground truth output at each previous time step;
determining, from the predictive posterior distribution for the time step, a conditional probability of the ground truth output at the time step, given the ground truth output at each previous time step;
generating an objective function for the time step that depends on the conditional probability of the ground truth output at the time step; and
generating the set of distribution parameters for the next time step by optimizing the objective function for the time step with respect to the set of distribution parameters for the time step.

7. The method of claim 6, wherein:
at each time step, the base neural network is configured to process the input at the time step, in accordance with a set of network parameters for the time step, to generate the embedding of the input at the time step, and
processing the data stream further comprises, at each time step:
obtaining the set of network parameters for the time step;
parametrizing the base neural network with the set of network parameters for the time step; and
generating a set of network parameters for the next time step by optimizing the objective function for the time step with respect to the set of network parameters for the time step.

8. The method of claim 6, wherein at each time step, the objective function for the time step comprises a logarithm of the conditional probability of the ground truth output at the time step.

9. The method of claim 6, wherein at each time step, generating the predictive posterior distribution for the time step comprises:
generating a marginal predictive posterior distribution for the time step that depends on the set of distribution parameters for the time step,
wherein the marginal predictive posterior distribution for the time step defines a conditional probability distribution over possible sets of weights for the time step, given the ground truth output at each previous time step;
generating a likelihood distribution for the time step that depends on the embedding of the input at the time step,
wherein the likelihood distribution for the time step defines a conditional probability distribution over possible ground truth outputs for the time step, given the set of weights for the time step; and
marginalizing, with respect to the possible sets of weights for the time step, the likelihood distribution for the time step over the marginal predictive posterior distribution for the time step.

10. The method of claim 9, wherein at each time step, marginalizing, with respect to the possible sets of weights for the time step, the likelihood distribution for the time step over the marginal predictive posterior distribution for the time step comprises:
performing a Monte Carlo estimation over the possible sets of weights for the time step.

11. The method of claim 9, wherein at each time step, the likelihood distribution for the time step is a Gaussian likelihood distribution or a softmax likelihood distribution.

12. The method of claim 9, wherein at each time step, generating the marginal predictive posterior distribution for the time step comprises:
obtaining a marginal posterior distribution for the previous time step,
wherein the marginal posterior distribution for the previous time step defines a conditional probability distribution over possible sets of weights for the previous time step, given the ground truth output at each previous time step;
generating the transition distribution for the time step in accordance with the set of distribution parameters for the time step; and
marginalizing, with respect to the possible sets of weights for the previous time step, the transition distribution for the time step over the marginal posterior distribution for the previous time step.

13. The method of claim 9, wherein processing the data stream further comprises, at each time step:
determining, from the likelihood distribution for the time step, a conditional likelihood of the ground truth output at the time step, given the set of weights for the time step; and
generating, via Bayes' rule, a marginal posterior distribution for the time step in accordance with the conditional likelihood of the ground truth output at the time step and the marginal predictive posterior distribution for the time step,
wherein the marginal posterior distribution for the time step defines a conditional probability distribution over possible sets of weights for the time step, given the ground truth output at the time step and each previous time step.

14. The method of claim 1, further comprising, before processing the data stream:
initializing an initial set of distribution parameters that parametrizes a prior distribution,
wherein the prior distribution defines a probability distribution over possible sets of weights prior a first of the plurality of time steps;
generating an initial set of weights using the initial set of distribution parameters; and
initializing the set of distribution parameters for the first time step that parametrizes the transition distribution for the first time step,
wherein the transition distribution for the first time step defines a conditional probability distribution over possible sets of weights for the first time step, give the initial set of weights prior the first time step.

15. The method of claim 14, wherein generating the initial set of weights using the initial set of distribution parameters comprises:
generating the prior distribution in accordance with the initial set of distribution parameters; and
sampling the initial set of weights from the prior distribution.

16. The method of claim 1, wherein the base neural network is a pre-trained neural network.

17. The method of claim 1, wherein the output network head comprises one or more linear neural network layers.

18. The method of claim 1, wherein the data stream is non-stationary.

19. A system comprising one or more computers and one or more storage devices communicatively coupled to the one or more computers, wherein the one or more storage devices store instructions that, when executed by the one or more computers, cause the one or more computers to perform a method for online inference involving a neural network comprising a base neural network and an output network head, wherein the method comprises:
receiving a data stream comprising a respective input at each of a plurality of time steps; and
processing the data stream to generate a respective predicted output at each time step that estimates a corresponding ground truth output for the time step, comprising, at each time step:
receiving the input at the time step;
obtaining a set of distribution parameters for the time step that parametrizes a transition distribution for the time step,
wherein the transition distribution for the time step defines a conditional probability distribution over possible sets of weights for the time step, given a set of weights for a previous time step;
generating a set of weights for the time step using the set of distribution parameters for the time step;
parametrizing the output network head with the set of weights for the time step; and
processing the input at the time step using the neural network to generate the predicted output at the time step, comprising:
processing the input at the time step using the base neural network to generate an embedding of the input at the time step; and
processing the embedding of the input at the time step using the output network head, in accordance with the set of weights for the time step, to generate the predicted output at the time step.

20. One or more non-transitory computer storage media storing instructions that, when executed by one or more computers, cause the one or more computers to perform a method for online inference involving a neural network comprising a base neural network and an output network head, wherein the method comprises:
receiving a data stream comprising a respective input at each of a plurality of time steps; and
processing the data stream to generate a respective predicted output at each time step that estimates a corresponding ground truth output for the time step, comprising, at each time step:
receiving the input at the time step;
obtaining a set of distribution parameters for the time step that parametrizes a transition distribution for the time step,
wherein the transition distribution for the time step defines a conditional probability distribution over possible sets of weights for the time step, given a set of weights for a previous time step;
generating a set of weights for the time step using the set of distribution parameters for the time step;
parametrizing the output network head with the set of weights for the time step; and
processing the input at the time step using the neural network to generate the predicted output at the time step, comprising:
processing the input at the time step using the base neural network to generate an embedding of the input at the time step; and
processing the embedding of the input at the time step using the output network head, in accordance with the set of weights for the time step, to generate the predicted output at the time step.
